(19) United States
(12) Patent Application Publication
(10) Pub. No.: US 2009/0032325 A1
(43) Pub. Date: Feb. 5, 2009

(54) Motor vehicle with a cargo compartment lid

(75) Inventors: Timo Frieb-Preis, Munstermaifeld (DE); Andreas Ritter, Hilgert (DE); Christian Schindlatz, Sinzig (DE)

Correspondence Address: COHEN, PONTANI, LIEBERMAN & PAVANE LLP, 551 FIFTH AVENUE, SUITE 1210, NEW YORK, NY, 10176, US

(73) Assignee: Stabilus GmbH, Koblenz (DE)

(21) Appl. No.: 12/215,773

(22) Filed: Jun. 30, 2008

(30) Foreign Application Priority Data
Jun. 30, 2007 (DE) 10 2007 030 496.1

(51) Int. Cl. B62D 25/12; B60P 7/02

(52) U.S. Cl. 180/286; 296/100.06

(57) ABSTRACT

A motor vehicle with a cargo compartment lid, such as a hinged trunk lid or tailgate, which can be moved between an open position and a closed position around a pivot axis includes, at least one lid position sensor is integrated into the cargo compartment lid in such a way that the arrangement or position of the cargo compartment lid in space can be detected.

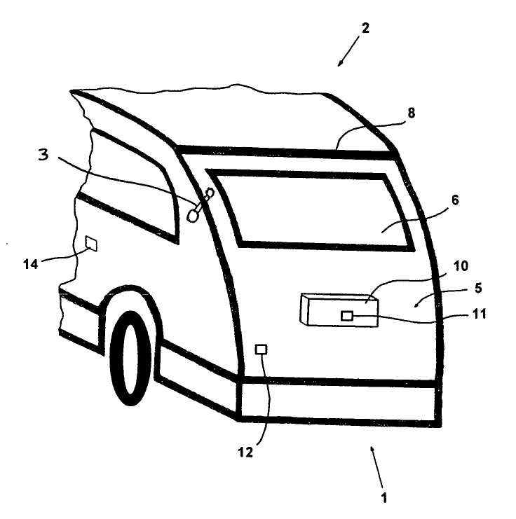

### BACKGROUND OF THE INVENTION

1. Field of the Invention

The invention relates to a motor vehicle with a cargo compartment lid such as, for example, a hinged trunk lid or a tailgate which can be moved between an open position and a closed position around a pivot axis.

2. Description of the Related Art

A folding roof for a motor vehicle with at least one roof element, which can move relative to the body of the motor vehicle, and with a position-measuring device for detecting the position of at least one roof element within its range of movement is known from European Patent EP 1 304 247 B1. This known position-measuring device has at least two position-detecting means, one of which is assigned to a roof element, the other either to a different roof element or to the body of the motor vehicle. The position-detecting means are designed as tilt sensors. Tilt sensors can be mounted on the movable vehicle components which participate in the movements of the folding roof such as the roof compartment lid or a variable roof compartment.

### SUMMARY OF THE INVENTION

An object of the present invention is to increase the operating convenience in a motor vehicle with a cargo compartment lid which can be moved between an open position and a closed position about a pivot axis.

In a motor vehicle with a cargo compartment lid, especially a hinged trunk lid or a tailgate, which can be moved between an open position and a closed position around a pivot axis, the object is achieved in that at least one lid position sensor, which cooperates with a drive device for the cargo compartment lid, is integrated into the cargo compartment lid in such a way that the arrangement or position of the cargo compartment lid in space is detected. The cargo compartment lid is, for example, the hinged tailgate or trunk lid of a passenger vehicle of the hatchback type or the tailgate of a combination passenger and delivery vehicle, also referred to as a “station wagon”. The drive device serves to move the cargo compartment lid from the open position into the closed position and/or vice versa. The lid position sensor is built into the cargo compartment lid or mounted on the cargo compartment lid. In addition to the arrangement or position of the lid in space, a reference signal for the lid position or lid location is preferably also entered into a control unit for the drive device. The reference signal identifies, for example, the position or location which the lid occupies when the cargo compartment is closed. This can be, for example, the condition which exists when the lock on the cargo compartment lid is locked. The exact position or location of the lid in space can be determined from the reference signal and the angle detected by the lid position sensor. The lid position sensor allows detection or measurement of variables such as the current tilt of the vehicle and to compensate for them by actuating the drive device for the cargo compartment lid correspondingly. Thus the lid is always closed the same way even though the external influences may differ, and the absolute position of the cargo compartment lid, especially the trunk lid or the tailgate, is determined.

According to one embodiment of the present invention, the lid position sensor is disposed a certain distance away from the pivot axis. The farther the lid position sensor is located from the pivot axis, the greater the distance which the lid position sensor travels when the cargo compartment lid moves. It thus becomes easier to determine the exact position, arrangement, or location of the lid as the location of the lid position sensor from the pivot axis increases.

In another embodiment of the present invention, the lid position sensor is installed near the point where the number plate or license plate of the motor vehicle is attached. This attachment point has been found to be especially advantageous within the scope of the present invention.

In a further embodiment of the present invention, the lid position sensor is integrated into a control unit for the drive device of the cargo compartment lid. The lid position sensor may alternatively or additionally be installed as an independent component in the cargo compartment lid or built into or integrated into the cargo compartment lid.

In yet another embodiment of the present invention, another lid position sensor is integrated into the cargo compartment lid a certain distance away from the first lid position sensor. The second lid position sensor makes it possible to detect the lid position or lid location with even greater accuracy.

According to another embodiment of the present invention, the second lid position sensor is located farther away from the pivot axis than is the first lid position sensor. The second lid position sensor may, for example, be located in the area of a taillight integrated into the cargo compartment lid.

According to a further embodiment of the present invention, a position sensor is attached to an unmoving part of the motor vehicle in addition to the at least one lid position sensor. This stationary position sensor detects the position or location of the motor vehicle. For this purpose, a position sensor already present in the vehicle or an additional stationary position sensor can be used.

In still another embodiment of the motor vehicle, the lid position sensor operates according to a thermal principle, in that the angle of the heat radiated by a heat source is detected. The angle detected by the lid position sensor serves to determine the position of the lid position sensor in space.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The sole FIGURE shows a perspective schematic diagram of the rear of a motor vehicle with a cargo compartment lid in the closed state according to an embodiment of the present invention.

### DETAILED DESCRIPTION OF THE PREFERRED EMBODIMENTS

The sole FIGURE shows a perspective schematic view of the rear 1 of a motor vehicle 2. In this case, the motor vehicle 2 is a combination passenger and delivery vehicle, referred to as a “station wagon”. The station wagon 2 has a cargo compartment lid 5, which is referred to as a rear tailgate. A rear window 6 is provided in the rear tailgate 5. The rear tailgate 5 can be swung around a pivot axis 8 from the closed position shown into an open position, in which the cargo compartment in the rear of the station wagon 2 is accessible.

The rear tailgate 5 of the inventive motor vehicle 2 pivots in response to a drive device 3 between the closed and the open position. Therefore, the rear tailgate 5 is also referred to as a driven rear tailgate 5. The distance traveled by the drive device or the angle to which the rear tailgate 5 has been moved can be detected by sensors. It is possible to use angle or linear sensors to generate absolute signals by the use of potentiometric, magnetoresistive, capacitive, or inductive methods or to generate incremental signals with the help of Hall effects. When sensors are used which measure only the changes in distance or angle (incremental sensors) or only the distances/angular positions of the drive unit or hatch (absolute sensors), the position of the motor vehicle itself is not detected. These types of sensors, furthermore, are often complicated to install.

In contrast, according to an aspect of the present invention, the arrangement or position of the rear tailgate in space is detected. For this purpose, at least one lid position sensor 11, 12 is mounted in the rear tailgate 5. The lid position sensor 11, 12 operates according to a thermal principle, according to which it detects the angle of the heat radiated by a heat source. The arrangement or position of the lid position sensor 11, 12 in space is calculated on the basis of this angle.

According to an exemplary embodiment, the lid position sensor 11 is integrated into a control unit 10 for the drive device. Alternatively or in addition, the lid position sensor 12 can be positioned at some other point in the rear tailgate 5.

According to another aspect of the invention, in addition to the position of the rear tailgate 5, a reference signal of the tailgate position is entered into the control unit 10 of the drive device. For the reference signal, it is possible, for example, to use the position which the tailgate occupies when the lock of the rear tailgate 5 is locked. The position of the rear tailgate 5 is calculated on the basis of this reference signal and the detected position of the rear tailgate 5. Possible variables, such as the tilt of the vehicle, can be measured by a stationary position sensor 14. The vehicle tilt can also be determined without a stationary position sensor as long as the rear tailgate remains in the reference position, in which, for example, the lock on the rear tailgate is locked.

These variables can be compensated by means of the appropriate actuation of the drive device. Thus, under different sets of external influences, it is possible for the drive device to ensure that the hatch is always closed in the same way. The inventive lid position sensors 11, 12 operate reliably under the effects of shocks, and they have no oscillatory behavior caused by mass inertia.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A motor vehicle comprising:
a cargo compartment lid movable between an open position and a closed position around a pivot axis; and
at least one lid position sensor, which cooperates with a drive device for said cargo compartment lid, integrated into the cargo compartment lid and detecting a position of said cargo compartment lid in space.

2. The motor vehicle according to claim 1, wherein said at least one lid position sensor is a certain distance away from the pivot axis.

3. The motor vehicle according to claim 1, wherein said at least one lid position sensor is located near a point where a number plate or license plate of the motor vehicle is attached.

4. The motor vehicle according to claim 1, further comprising a control unit for the drive device of the cargo compartment lid, said at least one lid position sensor being integrated into the control unit.

5. The motor vehicle according to claim 1, wherein another lid position sensor is integrated into the cargo compartment lid a certain distance away from the first lid position sensor.

6. The motor vehicle according to claim 5, wherein said second lid position sensor is located farther away from the pivot axis than is the first lid position sensor.

7. The motor vehicle according to claim 1, further comprising a stationary position sensor.

8. The motor vehicle of claim 1, wherein said at least one lid position sensor operates according to a thermal principle, according to which the angle of the heat radiated by a heat source is detected.

9. The motor of claim 4, wherein said control unit determines a reference signal of the lid position when said lid is in a predetermined position.

10. The motor vehicle of claim 9, wherein an exact position of lid is determined by the control unit using the reference signal and an angle detected by said at least one lid position sensor.

11. A motor vehicle comprising:
a cargo compartment lid movable between an open position and a closed position around a pivot axis; and
at least on lid position sensor integrated into the cargo compartment lid and detecting an arrangement of said cargo compartment lid in space.
